(19) United States
(12) Patent Application Publication
(10) Pub. No.: US 2024/0114533 A1
(43) Pub. Date: Apr. 4, 2024

(54) USER EQUIPMENT AND METHOD FOR SIDELINK COMMUNICATION

(71) Applicant: MEDIATEK INC., Hsinchu City (TW)

(72) Inventors: Lung-Sheng TSAI, Hsinchu City (TW); Tao CHEN, Beijing (CN)

(21) Appl. No.: 18/261,692

(22) PCT Filed: Jan. 14, 2022
(86) PCT No.: PCT/CN2022/072056

§ 371 Date: Jul. 17, 2023

(30) Foreign Application Priority Data
Jan. 18, 2021 (WO) PCT/CN2021/072541

(51) Int. Cl. H04W 72/40

(52) U.S. Cl. CPC H04W 72/40

(57) ABSTRACT

A method for sidelink communication is provided. The method is applied to a first UE in a sidelink communication to transmit signals to a second UE which is a peer receiving (peer-Rx) UE of the first UE. The method includes the following steps: maintaining a counter to record how many periodic reservations remain to be used for sidelink signal transmission, wherein the periodic reservations are associated with a reservation period and each periodic reservation is associated with at least one sidelink resource; determining whether a resource re-selection condition is met before the counter counts to 0, wherein the resource re-selection condition is associated with status of receiving responses corresponding to a subset of the sidelink resources; and reselectting at least one new sidelink resource for next periodic reservations when the resource re-selection condition is met.

### CROSS REFERENCE TO RELATED APPLICATIONS

This Application claims priority of Patent Cooperation Treaty (PCT) Patent Application No. PCT/CN2021/072541, filed on Jan. 18, 2021, the entirety of which is incorporated by reference herein.

### TECHNICAL FIELD

The invention generally relates to wireless communication technology, and more particularly, to a sidelink (SL) communication technology.

### BACKGROUND

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the Third Generation Partnership Project (3GPP). It is designed to better support mobile broadband Internet access by improving spectral efficiency, reducing costs, and improving services.

In the 5G NR, the Sidelink (SL) Vehicle-to-Everything (V2X) communication has the potential to modernize mobile communications for vehicles and significantly reduce the number of vehicular crashes and fatalities. Furthermore, SL V2X technologies can improve traffic management and the safety of autonomous vehicles. SL V2X technologies enable communications between vehicles as well as communications between a vehicle and other communication entities. In the SL V2X technologies, there are two kinds of mechanisms for allocating SL resources, i.e. Mode 1 (the SL resources are allocated by the network node) and Mode 2 (the SL resources are allocated by the UE itself). However, in Mode 2, an SL resource conflict may occur when communication between a peer-transmitting UE (peer-Tx UE) and a peer-receiving UE (peer-Rx UE) experiences interference from other Tx UEs.

### BRIEF SUMMARY OF THE INVENTION

A method and a user equipment (UE) for sidelink communication are provided to overcome the problems mentioned above.

An embodiment of the invention provides a method for sidelink communication. The method is applied to a first UE in a sidelink communication to transmit signals to a second UE which is a peer receiving (peer-Rx) UE of the first UE. The method comprises the following steps: maintaining a counter to record how many periodic reservations remain to be used for sidelink signal transmission, wherein the periodic reservations are associated with a reservation period and each periodic reservation is associated with at least one sidelink resource; determining whether a resource re-selection condition is met before the counter counts to 0, wherein the resource re-selection condition is associated with status of receiving responses corresponding to a subset of the sidelink resources; and reselectting at least one new sidelink resource for next periodic reservations when the resource re-selection condition is met.

In some embodiments, the resource re-selection condition comprises that the first UE does not receive any response for each first sidelink resource in all periodic reservations from the second UE in a first number of the reservation periods, wherein the first number of the reservation periods are continuous.

In some embodiments, the resource re-selection condition comprises that a number M₂ is greater than a first threshold, wherein the number M₂ is the number of continuous sidelink resources that the first UE does not receive corresponding responses.

In some embodiments, the resource re-selection condition comprises that a number M₃ is greater than a second threshold, wherein the number M₃ is the number of sidelink resources that are first sidelink resources in the periodic reservations and the first UE does not receive corresponding responses from the second UE during a period of time, and the period of time comprises at least one reservation period.

In some embodiments, the resource re-selection condition comprises that a number M₄ is greater than a third threshold, wherein the number M₄ is the number of sidelink resources that the first UE does not receive corresponding responses from the second UE during a period of time, wherein the period of time comprises at least one reservation period.

In some embodiments, the counter is reset to a new value when the new sidelink resource is reselected.

In some embodiments, the subset of the sidelink resources precludes the sidelink resources for re-transmission.

In some embodiments, each response for the sidelink resources associated with the periodic reservations from the second UE comprises an ACK response or a NACK response.

An embodiment of the invention provides user equipment (UE) for sidelink communication. The UE is applied to a first UE in a sidelink communication. The UE includes a radio frequency (RF) signal processing device and a processor. The RF signal processing device transmits periodic reservations to a second UE which is a peer-Rx UE of the first UE in the sidelink communication. The processor is coupled to the RF signal processing device. The processor maintains a counter to record how many periodic reservations remain to be used for sidelink signal transmission, wherein the periodic reservations are associated with a reservation period and each periodic reservation is associated with at least one sidelink resource. In addition, the processor determines whether a resource re-selection condition is met before the counter counts to 0, wherein the resource re-selection condition is associated with status of receiving responses corresponding to a subset of the sidelink resources, and reselects at least one new sidelink resource for next periodic reservations when the resource re-selection condition is met.

Other aspects and features of the invention will become apparent to those with ordinary skill in the art upon review of the following descriptions of specific embodiments of the UE and the method for sidelink communication.

### BRIEF DESCRIPTION OF THE DRAWINGS

The invention will become more fully understood by referring to the following detailed description with reference to the accompanying drawings, wherein:

FIG. 1 is a block diagram of a sidelink (SL) communications system 100 according to an embodiment of the invention.

FIG. 2 is a block diagram of a UE 200 according to an embodiment of the invention.

FIG. 3 is a flow chart illustrating a method for sidelink communication according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

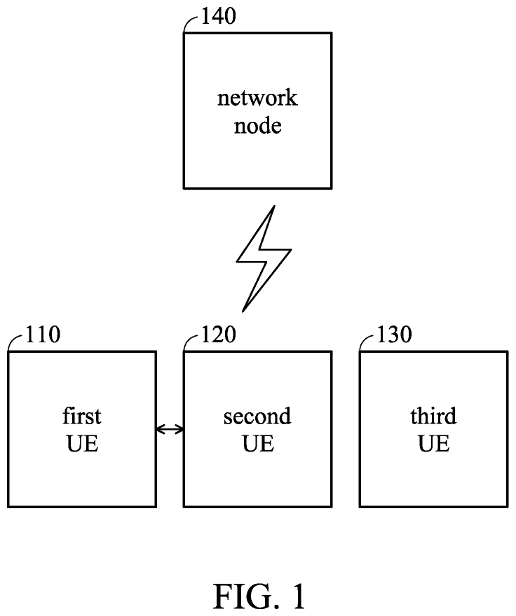

FIG. 1 is a block diagram of a sidelink (SL) communications system 100 according to an embodiment of the invention. As shown in FIG. 1, the sidelink communications system 100 may comprise a first user equipment (UE) 110, a second UE 120, a third UE 130 and a network node 140. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the first UE 110 may be regarded as a peer-transmitting UE (peer-Tx UE) and the second UE 120 may be regarded as a peer-receiving UE (peer-Rx UE), but the invention should not be limited thereto. In addition, in the embodiments of the invention, the third UE 130 may be a Tx UE or a Rx UE. The UE 110, the second UE 120 and the third UE 130 may communicate with each other through the sidelink technology.

In the embodiments of the invention, the network node 140 may be a base station, a gNodeB (gNB), a NodeB (NB) an eNodeB (eNB), an access point, an access terminal, but the invention should not be limited thereto. In the embodiments, the UE 110, the second UE 120, and/or the third UE 130 may communicate with the network node 140 through the fifth generation (5G) communication technology or 5G New Radio (NR) communication technology, but the invention should not be limited thereto.

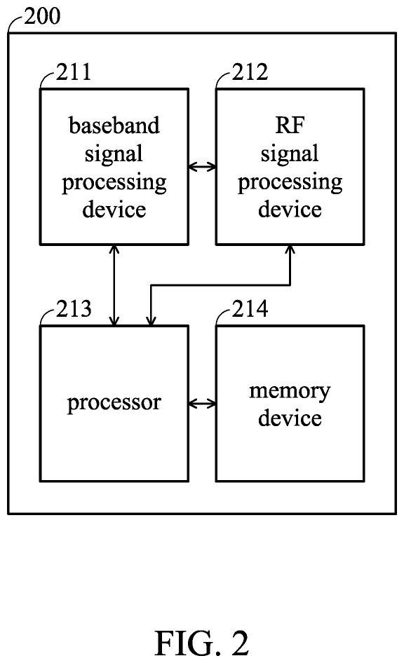

FIG. 2 is a block diagram of a UE 200 according to an embodiment of the invention. As shown in FIG. 2, the UE 200 may comprise at least a baseband signal processing device 211, a radio frequency (RF) signal processing device 212, a processor 213, a memory device 214 and an antenna module comprising at least one antenna. The UE 200 can be applied to the UEs 110˜130. It should be noted that in order to clarify the concept of the invention, the UE 200 of FIG. 2 presents a simplified block diagram in which only the elements relevant to the invention are shown. However, the invention should not be limited to what is shown in FIG. 2.

In the embodiments of the invention, the UE 200 may be a car, a smartphone, a laptop computer, or a wireless handset, but the invention should not be limited thereto.

The RF signal processing device 212 may receive RF signals via the antenna and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing.

The processor 213 may control the operations of the baseband signal processing device 211 and the RF signal processing device 212. According to an embodiment of the invention, the processor 213 may also be arranged to execute the program codes of the software modules of the corresponding baseband signal processing device 211 and/or the RF signal processing device 212. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software modules.

The memory device 214 may store the software and firmware program codes, system data, user data, etc. of the UE 110. The memory device 214 may be a volatile memory such as a Random Access Memory (RAM); a non-volatile memory such as a flash memory or Read-Only Memory (ROM); a hard disk; or a combination thereof.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the UE 200 may be extended further to comprise more than one antenna and/or more than one radio module, and the invention should not be limited to what is shown in FIG. 2.

In an embodiment of the invention, when a sidelink communication is established between a peer-Tx UE (i.e. the first UE 110) and a peer-Rx UE (i.e. the second UE 120), the peer-Tx UE (i.e., the first UE 110) may transmit a sidelink control information (SCI) to the peer-Rx UE (i.e. the second UE 120) through the sidelink resource. Specifically, the first UE 110 may transmit periodic reservations carried in the SCI to the second UE 120 through the sidelink resource in each reservation period. In an embodiment, in each reservation period, one sidelink resource is reserved for one periodic reservation. In another embodiment, in each reservation period, more than one sidelink resource is reserved for one periodic reservation. For example, there are 3 sidelink resources in a reservation period, first sidelink resource, second sidelink resource and third sidelink resource, but the invention should not be limited thereto. The first sidelink resource, second sidelink resource and third sidelink resource associated with one periodic reservation may be reserved at different time slots in a reservation period, e.g. the reserved time slots are t=k*P, t=k*P+t₁ and t=k*P+t₂ for the first sidelink resource, second sidelink resource and third sidelink resource respectively, wherein k is the number of reservation periods, P is the length of reservation period, t₁ is time offset between the first sidelink resource and the second sidelink resource, and t₂ is time offset between the first sidelink resource and the third sidelink resource and t₂ is greater than t₁.

In the embodiments of the invention, each SCI may comprise a first part and a second part. In NR, the first part of SCI is called 1^{st}-stage SCI and the second part of SCI is called 2^{nd}-stage SCI. The 1^{st}-stage SCI is potentially decodable by all UEs. When the second UE 120 receives the SCI from the first UE 110 in a time slot, the second UE 120 may decode the SCI from the first UE 110. It should be noted that in order to illustrate the embodiments of the invention, the SCI from the first UE 110 successfully decoded by the second UE 120 is regarded as a first SCI and the following one or more second SCIs transmitted by the first UE 110 are regarded as second SCIs. When the second UE 120 successfully decodes the first SCI from the first UE 110, the second UE 120 may obtain resource allocation information. The resource allocation information may indicates one or more time slots allocated for following one or more second SCIs to be transmitted by the first UE 110. In addition, the resource allocation information may indicates a periodic reservation interval for periodic reservations of the following one or more second SCIs in multiple periodic slots. The periodic reservation interval may be a time gap between the first SCI which is successfully decoded and the next second SCI from the peer-Tx UE (i.e. the first UE 110) or a time gap between two successive second SCIs from the peer-Tx UE (i.e. the first UE 110). For example, if the periodic reservation interval obtained from the resource allocation information in slot #n is P slot time (e.g. 100 milliseconds), the second UE 120 may know that the next second SCI from the first UE 110 will be received at slot #(n+P). In an embodiment of the invention, the periodic reservation interval may be carried in the first part of the SCI. It should be noted that besides the periodic reservation interval, the decoded SCI may comprise other information.

According to an embodiment of the invention, when the second UE 120 successfully decodes the SCI from the first UE 110, the second UE 120 may transmit an Acknowledgment (ACK) response to the first UE 110. In addition, when the second UE 120 does not successfully decode the SCI from the first UE 110, it means that a resource conflict (or resource collision) may be occurred (i.e. the second UE 120 may not realize that the first UE 110 transmits data to it). If the second UE 120 receives a SCI but does not transmit an ACK response or a NACK response to the first UE 110, the second UE 120 may transmit a Negative-Acknowledgment (NACK) response to the first UE 110.

According to an embodiment of the invention, the first UE 110 may maintain a counter to record how many remaining periodic reservations of sidelink resource to be used for sidelink signal transmission, wherein the periodic reservations are associated with a reservation period (i.e. the periodic reservation interval). When the first UE 110 receives an ACK response or a NACK response for the periodic reservation from the second UE 120, the counter value of the counter will be subtracted by 1. In an embodiment of the invention, an initial counter value of the counter may be pre-set by the first UE 110 based on the periodic reservations. According to an embodiment of the invention, the ACK response or NACK response may be comprised in a Hybrid Automatic Repeat request (HARQ) feedback from the second UE 120.

According to an embodiment of the invention, the first UE 110 may determine whether a resource re-selection condition is met in each reservation period before the counter counts to 0. When the resource re-selection condition is met before the counter counts to 0, the first UE 110 may reselect at least one new sidelink resource for transmitting the periodic reservations. According to an embodiment of the invention, when the new sidelink resource is reselected, the counter may be reset to a new value.

According to an embodiment of the invention, the resource re-selection condition may comprise that the first UE 110 does not receive any response (i.e. ACK response or NACK response) for the periodic reservations of a first sidelink resource within each reservation period from the second UE 120 in a first number of reservation periods. In the embodiment, if each periodic reservation is associated with more than one sidelink resource (e.g. 3 sidelink resources, first sidelink resource, second sidelink resource and third sidelink resource, but the invention should not be limited thereto) in each reservation period, the first UE 110 may determine whether the resource re-selection condition is met only based on the number of responses for the first sidelink resource associated with each periodic reservation. In addition, in the embodiment, a first number of reservation periods are continuous reservation periods, e.g. 10 continuous reservation periods. In the embodiment, “a first number” may be a configurable parameter or a predefined value, and it is regarded as a threshold for the number of continuous reservation periods. When the number of continuous reservation periods in which the first UE 110 does not receive any response for the first sidelink resource associated with all periodic reservations from the second UE 120 is larger than first number, the first UE 110 may determine the resource re-selection condition is met. For example, if the first number is 5, when the first UE 110 does not receive any response for the first sidelink resource associated with each periodic reservation from the second UE 120 in 5 continuous reservation periods, the first UE 110 may determine the resource re-selection condition is met.

According to another embodiment of the invention, the resource re-selection condition may comprise that the first UE 110 does not receive any response (i.e. ACK response or NACK response) for M₂ continuous sidelink resources from the second UE 120 and the M₂ is greater than a threshold. In the embodiment, if each periodic reservation is associated with more than one sidelink resource (e.g. 3 sidelink resources, first sidelink resource, second sidelink resource and third sidelink resource, but the invention should not be limited thereto) in each reservation period, the first UE 110 may determine whether the resource re-selection condition is met based on the number of responses for all sidelink resources associated with each periodic reservation. In addition, in the embodiment, M₂ is the number of continuous sidelink resources that the first UE 110 does not receive any response (i.e. ACK response or NACK response) for the M₂ continuous sidelink resources. In the embodiment, “threshold” may be a configurable parameter or a predefined value. When M₂ is greater than the threshold, the first UE 110 may determine the resource re-selection condition is met. For example, it is assumed the threshold is 5. When the first UE 110 does not receive any response for more than 5 continuous sidelink resources from the second UE 120, the first UE 110 may determine the resource re-selection condition is met.

According to another embodiment of the invention, the resource re-selection condition comprises that the first UE 110 does not receive responses (i.e. ACK response or NACK response) for M₃ first sidelink resource associated with the periodic reservations from the second UE 120 during a period of time (i.e. within a time window or a time interval) and M₃ is greater than a threshold. In the embodiment, if each periodic reservation is associated with more than one sidelink resource (e.g. 3 sidelink resources, first sidelink resource, second sidelink resource and third sidelink resource, but the invention should not be limited thereto) in each reservation period, the first UE 110 may determine whether the resource re-selection condition is met only based on the first sidelink resource associated with each periodic reservations during a period of time. In the embodiment, the time window (or time interval) may comprise at least one reservation period. In the embodiment, M₃ is the number of first sidelink resources that the first UE 110 does not receive response (i.e. ACK response or NACK response) for the M₃ first sidelink resources during a period of time. In addition, in the embodiment, “threshold” may be a configurable parameter or a predefined value. When the number of first sidelink resources that the first UE 110 does not receive responses within the time window is greater than the threshold, the first UE 110 may determine the resource re-selection condition is met. For example, it assumed that the length of the time window is 5 reservation periods and the threshold is 3 (i.e. the first UE 110 can receive at most 5 responses for the first sidelink resources within the time window). When the number of first sidelink resources that the first UE 110 does not receive responses within the time window is greater than 3 (i.e. M₃ is greater than the threshold), the first UE 110 may determine the resource re-selection condition is met.

According to another embodiment of the invention, the resource re-selection condition comprises that the first UE 110 does not receive responses (i.e. ACK response or NACK response) for M₄ sidelink resources from the second UE 120 during a period of time (i.e. within a time window or a time interval) and M₄ is greater than a threshold. In the embodiment, if each periodic reservation is associated with more than one sidelink resource (e.g. 3 sidelink resources, first sidelink resource, second sidelink resource and third sidelink resource, but the invention should not be limited thereto) in each reservation period, the first UE 110 may determine whether the resource re-selection condition is met based on all sidelink resources associated with each periodic reservations during a period of time. In the embodiment, the time window (or time interval) may comprise at least one reservation period. In the embodiment, M₄ is the number of sidelink resources that the first UE 110 does not receive response (i.e. ACK response or NACK response) for the M₄ sidelink resources during a period of time. In addition, in the embodiment, “threshold” may be a configurable parameter or a predefined value. When the number of sidelink resources that the first UE 110 does not receive responses within the time window is greater than the threshold, the first UE 110 may determine the resource re-selection condition is met. For example, it assumed that the number of sidelink resources associated with each periodic reservation is 3, the length of the time window is 5 reservation periods and the third number is 6 (i.e. the first UE 110 can receive at most 15 responses for the sidelink resources within the time window). When the number of sidelink resources that the first UE 110 does not receive responses within the time window is greater than 6 (i.e. M₄ is greater than the threshold), the first UE 110 may determine the resource re-selection condition is met.

According to an embodiment of the invention, when the first UE 110 counts the number of sidelink resources that the first UE 110 does not receive response (i.e. ACK response or NACK response) as discussed in the above embodiments, the first UE 110 may preclude the sidelink resource for sidelink signal re-transmission. For example, when the first UE 110 receives a NACK response (i.e. sidelink signal re-transmission) for a sidelink resource from the second UE 120, the first UE 110 may re-transmit the periodic reservation to the second UE 120, but the first UE 110 may ignore the sidelink resource for sidelink signal re-transmission when the first UE 110 counts the number of sidelink resources that the first UE 110 does not receive response (i.e. ACK response or NACK response) as discussed in the above embodiments.

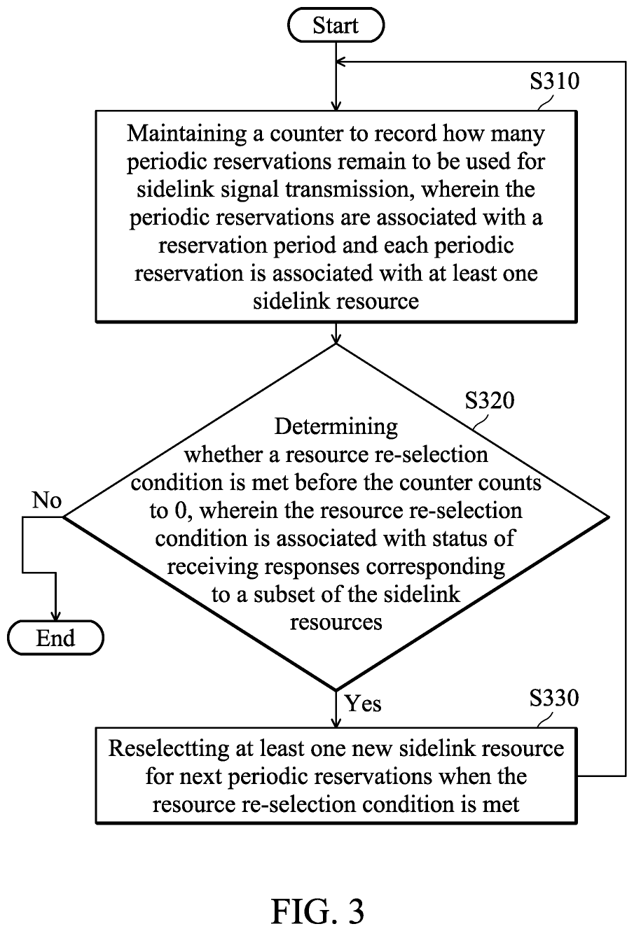

FIG. 3 is a flow chart illustrating a method for sidelink communication according to an embodiment of the invention. The method for sidelink communication can be applied to a peer-Tx UE (e.g. the first UE 110) in the sidelink communication system 100. In the method, a radio frequency (RF) signal processing device of the first UE 110 may transmit periodic reservations to a second UE 120 which is a peer-Rx UE of the first UE 110 in the sidelink communication.

As shown in FIG. 3, in step S310, a processor of the first UE 110 may maintain a counter to record how many periodic reservations remain to be used for sidelink signal transmission, wherein the periodic reservations are associated with a reservation period and each periodic reservation is associated with at least one sidelink resource.

In step S320, the processor of the first UE 110 may determine whether a resource re-selection condition is met before the counter counts to 0, wherein the resource re-selection condition is associated with response status of receiving responses corresponding to a subset of the sidelink resources. In some embodiments, the subset of the sidelink resources may be the first sidelink resources of the sidelink resources. In some embodiments, the subset of the sidelink resources may be some sidelink resources (i.e. these sidelink resources are not limited to the first sidelink resources) of the sidelink resources.

When the resource re-selection condition is met before the counter counts to 0, step S330 is performed. In step S330, the processor of the first UE 110 may reselects at least one new sidelink resource for next periodic reservations when the resource re-selection condition is met.

In an embodiment, in the method for sidelink communication, the resource re-selection condition comprises that the first UE 110 does not receive any response for each first sidelink resource in all periodic reservations from the second UE 120 in a first number of the reservation periods, wherein the first number of the reservation periods are continuous.

In another embodiment, in the method for sidelink communication, the resource re-selection condition comprises that a number M₂ is greater than a first threshold, wherein the number M₂ is the number of continuous sidelink resources that the first UE 110 does not receive corresponding responses from the second UE 120.

In another embodiment, in the method for sidelink communication, the resource re-selection condition comprises that a number M₃ is greater than a second threshold, wherein the number M₃ is the number of sidelink resources that are the first sidelink resources in the periodic reservations and the first UE 110 does not receive corresponding responses from the second UE 120 during a period of time, and the period of time comprises at least one reservation period.

In another embodiment, in the method for sidelink communication, the resource re-selection condition comprises that a number M₄ is greater than a third threshold, wherein the number M₄ is the number of sidelink resources that the first UE 110 does not receive corresponding responses from the second UE 120 during a period of time, wherein the period of time comprises at least one reservation period.

In an embodiment, in the method for sidelink communication, the counter is reset to a new value when the new sidelink resource is reselected.

In an embodiment, in the method for sidelink communication, the subset of the sidelink resources precludes the sidelink resources for re-transmission.

In an embodiment, in the method for sidelink communication, each response for the sidelink resources associated with the periodic reservations from the second UE may comprise ACK response or NACK response.

In the method for allocating sidelink resources provided in the invention, in Mode 2 of the SL V2X technology, when a resource conflict (or resource collision) occurs in the sidelink communication, the allocation of the sidelink resources will be more flexible and efficient.

Use of ordinal terms such as “first”, “second”, “third”, etc., in the disclosure and claims may be for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for sidelink communication, wherein the method is applied to a first UE in a sidelink communication to transmit signals to a second UE which is a peer receiving (peer-Rx) UE of the first UE, comprising:
maintaining a counter to record how many periodic reservations remain to be used for sidelink signal transmission, wherein the periodic reservations are associated with a reservation period and each periodic reservation is associated with at least one sidelink resource;
determining whether a resource re-selection condition is met before the counter counts to 0, wherein the resource re-selection condition is associated with status of receiving responses corresponding to a subset of the sidelink resources; and
reselectting at least one new sidelink resource for next periodic reservations when the resource re-selection condition is met.

2. The method of claim 1, wherein the resource re-selection condition comprises:
the first UE does not receive any response for each first sidelink resource in all periodic reservations from the second UE in a first number of the reservation periods, wherein the first number of the reservation periods are continuous.

3. The method of claim 1, wherein the resource re-selection condition comprises:
a number M₂ is greater than a first threshold, wherein the number M₂ is the number of continuous sidelink resources that the first UE does not receive corresponding responses.

4. The method of claim 1, wherein the resource re-selection condition comprises:
a number M₃ is greater than a second threshold, wherein the number M₃ is the number of sidelink resources that are first sidelink resources in the periodic reservations and the first UE does not receive corresponding responses from the second UE during a period of time, and the period of time comprises at least one reservation period.

5. The method of claim 1, wherein the resource re-selection condition comprises:
a number M₄ is greater than a third threshold, wherein the number M₄ is the number of sidelink resources that the first UE does not receive corresponding responses from the second UE during a period of time, wherein the period of time comprises at least one reservation period.

6. The method of claim 1, further comprising:
resetting the counter to a new value when the new sidelink resource is reselected.

7. The method of claim 1, wherein the subset of the sidelink resources precludes the sidelink resources for re-transmission.

8. The method of claim 1, wherein each response for the sidelink resources associated with the periodic reservations from the second UE comprises an ACK response or a NACK response.

9. A UE for allocating sidelink resource and for sidelink signal transmission in a sidelink communication, applied to a first UE in a sidelink communication, comprising:
a radio frequency (RF) signal processing device, transmitting periodic reservations to a second UE which is a peer-Rx UE of the first UE in the sidelink communication; and
a processor, coupled to the RF signal processing device, wherein the processor maintains a counter to record how many periodic reservations remain to be used for sidelink signal transmission, wherein the periodic reservations are associated with a reservation period and each periodic reservation is associated with at least one sidelink resource, determines whether a resource re-selection condition is met before the counter counts to 0, wherein the resource re-selection condition is associated with status of receiving responses corresponding to a subset of the sidelink resources, and reselects at least one new sidelink resource for next periodic reservations when the resource re-selection condition is met.

10. The UE of claim 9, wherein the resource re-selection condition comprises that the first UE does not receive any response for each first sidelink resource in all periodic reservations from the second UE in a first number of the reservation periods, wherein the first number of the reservation periods are continuous.

11. The UE of claim 9, wherein the resource re-selection condition comprises that a number M₂ is greater than a first threshold, wherein the number M₂ is the number of continuous sidelink resources that the first UE does not receive corresponding responses.

12. The UE of claim 9, wherein the resource re-selection condition comprises that a number M₃ is greater than a second threshold, wherein the number M₃ is the number of sidelink resources that are first sidelink resources in the periodic reservations and the first UE does not receive corresponding responses from the second UE during a period of time, and the period of time comprises at least one reservation period.

13. The UE of claim 9, wherein the resource re-selection condition comprises that a number M₄ is greater than a third threshold, wherein the number M₄ is the number of sidelink resources that the first UE does not receive corresponding responses from the second UE during a period of time, wherein the period of time comprises at least one reservation period.

14. The UE of claim 9, wherein the counter is reset to a new value when the new sidelink resource is reselected.

15. The UE of claim 9, wherein the subset of the sidelink resources precludes the sidelink resources for re-transmission.

16. The UE of claim 9, wherein each response for the sidelink resources associated with the periodic reservations from the second UE comprises an ACK response or a NACK response.
